(19) United States
(12) Patent Application Publication
(10) Pub. No.: US 2025/0322971 A1
(43) Pub. Date: Oct. 16, 2025

(54) Tailoring the Pushing Profile of an ICF Target with a Dense Propellant Region

(71) Applicants: Robert O. Hunter, JR., Solana Beach, CA (US); Eric W. Cornell, Colorado Springs, CO (US)

(72) Inventors: Robert O. Hunter, JR., Solana Beach, CA (US); Eric W. Cornell, Colorado Springs, CO (US)

(73) Assignee: Innoven Energy LLC, Solana Beach, CA (US)

(21) Appl. No.: 19/092,933

(22) Filed: Mar. 27, 2025

Related U.S. Application Data
(60) Provisional application No. 63/570,712, filed on Mar. 27, 2024.

(51) Int. Cl. G21B 1/19; G21B 1/03; G21B 1/23

(52) U.S. Cl. CPC G21B 1/19; G21B 1/03; G21B 1/23

(57) ABSTRACT

An ICF target is designed to use external energy to compress, heat and ignite the fusion fuel within it. If a sufficient amount of fusion fuel is compressed and heated appropriately, a self-sustaining fusion reaction can occur, in which energy produced by fusion reactions continues to heat and ignite the fusion fuel within. Due to the precise selection of the key elements and unique configuration in this ICF target design, the uniformity and efficiency may substantially improve. More specifically, the unique use and composition of a void region and lamina as described herein, will advantageously allow for a smoother profile while still using a dense propellant region. This is extremely important because it allows for the non-uniformity in the x-ray radiation to be smoothed and then passed on to energize the propellant regions and the subsequent shock that the pusher shell creates by its implosion in a controlled manner.

### CROSS-REFERENCE TO RELATED APPLICATION

The present application claims priority to provisional patent application No. 63/570,712 filed on Mar. 27, 2024, the entire contents of which are incorporated herein by reference.

### BACKGROUND

Nuclear fusion by inertial confinement (Inertial Confinement Fusion or “ICF”) utilities nuclear fusion reactions to produce energy. In most types of ICF systems, an external drive mechanism, such as a laser, delivers energy to a target containing nuclear fusion fuel. The target is designed to use this energy to compress, heat and ignite the fusion fuel within it. If a sufficient amount of fuel is compressed sufficiently and heated sufficiently, a self-sustaining fusion reaction can occur, in which energy produced by fusion reactions continues to heat or burn the fuel (“ignition”). The inertia of the compressed fuel can keep it from expanding long enough for significant energy to be produced, before expansion of the fuel and the resultant cooling terminates the fusion reaction. Most conventional ICF target designs involve a spherical target which is imploded symmetrically from all directions, relying on stagnation of inwardly-accelerated fuel at the center of the sphere to produce the required densities and temperatures.

Production of the very high temperatures and densities required for fusion ignition may require a substantial amount of energy. The exact amount of energy required depends on the specific target design in use. In order to be useful for energy generation, the target must be capable of producing more energy from fusion reactions than was required to ignite it. In addition, the amount of energy required by the target must be physically and/or economically realizable by the drive mechanism being used.

For this reason, conventional ICF target designs have focused on achieving the required temperatures and densities as efficiently as possible. These designs are often complex in their construction and operation, and sensitive to imperfection in the target's manufacturing and to non-uniformity in the delivery of energy to the target from the drive mechanism. Imperfections and non-uniformity can lead to asymmetry in the target's implosion, which may reduce the densities and temperatures achieved, potentially below the threshold required for ignition. Furthermore, successful operation of these complex designs often requires achieving a precise balance between multiple competing physical processes, many of which are poorly understood and difficult to model. When actually constructed and deployed, these complex ICF target designs often fail to perform as their designers intended.

The conventional approach to ICF target design is exemplified by the Department of Energy's program, National Ignition Facility (“NIF”) target design. NIF target design, as described in Lindl (Physics of Plasmas v11, number 2), consists of a mostly plastic or beryllium ablator region which surrounds a cryogenic deuterium and tritium (D-T) ice, and a central void which is filled with very low-density D-T gas. The target is then placed in a cylindrical hohlraum. The entire target assembly (hohlraum and target) are then placed in the target chamber, and the hohlraum illuminated with a number (192) of discrete beams of laser light. The hohlraum then converts the energy to x-rays, which then ablate the ablator region, and by the reactive force, drives the D-T inward. The combination of a non-spherical hohlraum and illumination leads directly to spatial non-uniformities in the target absorbed energy. Even in configurations with spherical hohlraums, the illumination is never spherically symmetric because entrance holes are required to admit the beams. This asymmetrical illumination leads to unsymmetrical energy absorption by the target which in turn seeds instabilities that can prevent the temperature and density from achieving the necessary values to initiate a useful or self-perpetuating fusion reaction.

There is a need in ICF target design to create an ICF target assembly where the radiation smooths faster during the implosion. It would be advantageous to efficiently transfer energy by allowing for tamping of the pushing profile, specifically to push later in time, after the laser pulse has ended.

### SUMMARY

The spectrum of energy output from an ICF target may be comprised of charged particles, neutrons, x-ray radiation, and an expanding field of target debris. Embodiments described herein can contain the radiation output of an ICF target by absorbing the radiation energy. In some embodiments, a confinement chamber for Inertial Confinement Fusion (ICF) may include a closed hohlraum and ICF target, entirely referred to as an ICF target assembly. It would be advantageous to tailor the pushing profile by configuring the ICF target assembly as described herein, specifically to push later in time.

### DRAWINGS

FIG. 1 shows a target assembly containing a propellant region.

FIG. 2 shows target assembly containing a dense propellant region and thin layer of gold.

### SPECIFICATION

Inertial Confinement Fusion reactor chambers can be designed to contain an Inertial Confinement Fusion (“ICF”) target being imploded and capture the resulting energy output from the reaction in the forms of neutrons, radiation, and/or debris. Such chambers can generally include a combination of neutron moderating layers, neutron absorbing layers, neutron shielding layers, radiation capturing layers, sacrificial layers, shock absorbers, tritium breeding layers, tritium breeders, coolant systems, injection nozzles, inert gas injection nozzles, sputterers, sacrificial coating injection nozzles, beam channels, target supporting mechanism, and/or purge ports, among others. Generally speaking, neutron moderating material can be constructed from graphite and may be naturally or artificially doped, combined, allowed, and/or mixed with neutron absorbing material and/or have a thickness of one or more neutron mean free path lengths (e.g., 0.3-1.0 m). Neutron absorbing material may include boron, cadmium, lithium, etc. Radiation tiles or layers can be disposed throughout the chamber to absorb radiation from the reaction.

Such cylindrical chambers can be used with both directional and omni-directional targets. For instance, for use with directional targets where neutrons are not directed and radiations and debris are directed along the longitudinal length of the cylinder, a chamber can have neutron moderating and/or absorbing material concentrated near the center of the cylinder, and radiation and debris collecting material can be concentrated in the outer sections of the cylindrical chamber. Various other specific embodiments and configurations are described.

The term “approximately” and “about” refers a given value ranging plus/minus 20%. For example, the phrase “approximately 10 units” is intended to encompass a range of 8 units to 12 units.

The term “neutron” refers to a subatomic particle with no electrical charge. Their lack of a charge means that free neutrons generally have a greater free range in matter than other particles.

The term “proton” refers to a subatomic particle with a positive electrical charge.

The term “electron” refers to a subatomic particle with a negative electrical charge, exactly opposite to that of a proton and having less mass than a proton and a neutron.

The term “atom” refers to a particle of matter, composed of a nucleus of tightly bound protons and neutrons, with an electron shell. Each element has a specific number of protons. Atoms under ordinary conditions have the same number of electrons as protons, so that their charges cancel.

The term “isotope” refers to atoms of the same element that have the same number of protons, but a different number of neutrons. Isotopes of an element are generally identical chemically but have different probabilities of undergoing nuclear reactions. The term “ion” refers to a charged particle, such as a proton or a free nucleus.

The term “plasma” refers to the so-called fourth state of matter, beyond solid, liquid, and gas. Matter is typically in a plasma state when the material has been heated enough to separate electrons from their atomic nuclei.

The term “Bremsstrahlung radiation” refers to radiation produced by interactions between electrons and ions in a plasma. One of the many processes that can cool a plasma is energy loss due to Bremsstrahlung radiation.

In thermodynamics the term “pressure-volume work” or “PdV” refers to the amount of energy or work it takes to move an object against a force. Gases can do work through expansion or compression against a constant external pressure. When the gas expands against an external pressure, the gas transfers some energy to its surroundings. Thus, the negative work decreases the overall energy of the gas. When the gas is compressed, energy is transferred to the gas, so the energy of the gas increases due to positive work.

The term “runaway burn” or “high-temperature burn” refers to a fusion reaction that heats itself and reaches a very high temperature. Because the deuterium and tritium (D-T) reaction rate increases with temperature, peaking at 67 keV, a D-T plasma heated to ignition temperatures may rapidly self-heat and reach extremely high temperatures, approximately 100 keV, or higher.

For targets burning advanced fuels such as D-D, but particularly D-³He and p-¹¹B, the output may be substantially larger in radiation and less in neutrons and debris. The radiation output may be at 1 KeV in a blackbody spectrum (if the interior structure of target ionized and became transparent to x-ray radiation-similar to the look of Bremsstrahlung). However, if the lower energy part of the spectrum is blocked by tailoring the target materials, then the photon energy would be, say, all above 2 KeV. The spectrally averaged deposition is then in the range of 10 cm²/g for Beryllium. Obviously, the hotter the target, the better. By 10 KeV, the absorption value would be approaching 0.1 cm²/g leading to 3 m² per side. In such a case, a small radius (1 meter) cylinder might be sufficient to reduce any damage to the containment structure. This class of target and converter has the potential for very compact converters.

The term “Z” refers to the atomic number of an element, i.e., the number of protons in the nucleus. The term “A” refers to the atomic mass number of an element, i.e., the number of protons and neutrons in the nucleus. At the pressures and temperatures involved in imploding and burning ICF targets, specific material properties that one observes in everyday life (hardness, strength, room-temperature, thermal conductivity, etc.) is irrelevant, and the hydrodynamic behavior of a material can depend most strongly on the material's average atomic number, atomic mass number, and solid density.

As such, in discussing material requirements in ICF targets, it is convenient to discuss classes of material. For the purposes of the following discussion, the term “low-Z” will refer to materials with an atomic number of 1-5 (i.e., hydrogen to boron); the term “medium-Z” will refer to materials with an atomic number between 6-47 inclusive of the endpoints (i.e., carbon to silver); and the term “high-Z” will refer to materials with an atomic number of 48 and greater (i.e., cadmium and above). Unless otherwise stated, the use of these terms to describe a class of material for a specific function is intended only to suggest that this class of material may be particularly advantageous for that function, and not (for instance) that a “high-Z” material could not be substituted where a “medium-Z” material is suggested, or vice-versa.

Specific material choice is still important, where indicated, as different isotopes of the same element undergo completely different nuclear reactions, and different elements may have different radiation opacities for specific frequencies. The differing solid densities of materials with similar Z is also important for certain design criteria.

The term “sparkplug” is defined as a device for burning the main fuel source wherein the neutrons initially couple to the outer fuel.

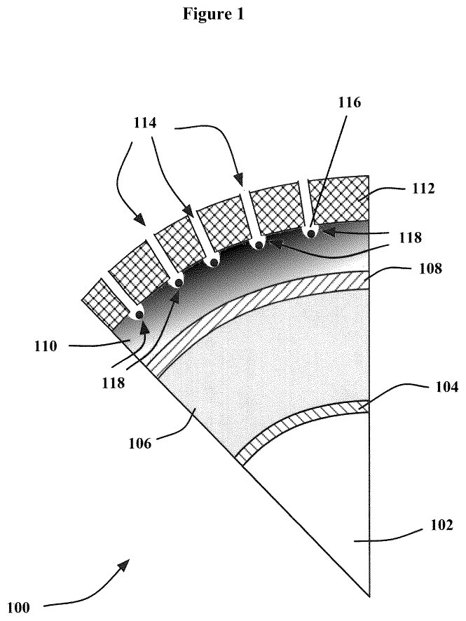

Target assembly 100 (FIG. 1) is defined as the ICF target and hohlraum. Target assembly 100 comprises a central spherical fuel region, inner fuel region 102 of an ICF target. Inner fuel region 102 may be filled with deuterium-tritium gas having a low-density of about 0.1 g/cm³. Surrounding inner fuel region 102 is inner shell 104 and outer shell 108. Inner shell 104 may be a spherical shell of solid tungsten with an outer radius of about 0.0821 cm. Outer shell 108 may be a spherical shell of tungsten with an inner radius of about 0.2293 cm and an outer radius of about 0.2355 cm. In the space between inner shell 104 and outer shell 108 is outer fuel region 106. Outer fuel region 106 may be filled with deuterium-tritium gas having a low-density of about 0.21 g/cm³. A density higher than this would make deuterium-tritium to be in a solid-state phase.

Surrounding outer shell 108 is propellant region 110. Propellant region 110 may have an outer radius of about 0.3083 cm and comprise beryllium foam at a density of about 1.0 g/cm³. Surrounding propellant region 110 is hohlraum 112, a spherical shell of solid tungsten and may have an outer radius of about 0.3212 cm. A multitude of cylindrical beam channels 114, each having a dimeter of 100 μm, penetrate the entire thickness of hohlraum 112. The long axis of each beam channel 114 is normal to the surface of hohlraum 112. At the end of each beam channel 114, where they exit hohlraum 112, is a hemispherical cavity 116 in propellant region 110. These cavities 116 are approximately 100 μm in radius. Centered in the curvature of each cavity 116, and coaxial with each beam channel 114, is a gold foam radiator 118. Each gold foam radiator 118 is a sphere of gold foam 50 μm in radius, having a density of approximately 10 g/cm³.

Propellant region 110 may be made up of one single material or a plurality of different materials. One may layer a plurality of different materials across the propellant region 110; for example, by alternating two materials such as beryllium and carbon in a layering fashion. Or one may change the density of a material across the propellant region 110 by grading or varying the density of a material from an outer to inner region; for example, by linearly increasing the density of a material such as carbon from about 0.1 g/cm³ to about 2.0 g/cm³, or by gradually changing the density of a material or by other unique distinctions among the plurality of different materials across the propellant region. Further, one may change the density of a material across the propellant region 110 by using a distinctly different density of a material; for example, using a material such as carbon with a density of about 0.5 g/cm³ in the lower half and carbon with a density of about 1.8 g/cm³ in the upper half. In addition to changing the density gradient in various ways as discussed above, one could change the atomic number (Z) of the material, by either doping the propellant region 110 with a low-Z material or a high-Z material.

Target assembly 100 may be ignited in the following manner. Target assembly 100 is placed in an ICF reaction chamber, configured to contain the energy that will be released by the target. An ICF laser is configured in such a way as to produce a pattern of 202 spots of laser light, each 100 microns in diameter, aligned with each of the 202 beam channels 114. These spots are produced as a 0.5 nanosecond pulse of approximately constant power having a total energy of 9.9 MJ, with the pulse energy evenly distributed between all 202 spots.

The laser light is first absorbed in the gold radiators 118 through a combination of collisional and resonance absorption, and this should occur before significant hydrodynamic motion occurs in the target. The gold radiators 118 re-radiate the laser energy as x-ray radiation into the propellant region 110. The propellant region 110 becomes ionized and optically thin to x-ray radiation. Radiation transport and thermal conduction in the propellant region distributes the laser energy throughout the propellant region 110.

Ultimately, approximately 1.9 MJ of energy may be lost due to radiation and heated material escaping back out the beam channels 114, and the total energy ultimately coupled to the target assembly in this embodiment may be approximately 8 MJ. The total energy coupled to metal shell 108 and the components inside (the “fuel capsule”) may be approximately 2.25 MJ.

As propellant region 110 is energized, radiation penetrates outer shell 108 which heats an outer layer of the shell material. The outward expansion of this outer layer of outer shell 108 is tamped by the material pressure in propellant region 110 and the mass of metal hohlraum 112. A denser material requires more mass to tamp the outer shell 108, this additional pressure on the outer shell 108 prevents it from expanding outwards. The inner part of outer shell 108 is thus impulsively accelerated inwards, driving a strong shock into outer fuel region 106. If the lower half of propellant region 110 has a density of about 0.5 g/cm³ and the upper half has a density of about 1.8 g/cm³, the upper region will absorb more energy; however, the lower region will tamp the outer shell 108 first, whereas the upper region, being more distant from outer shell 108 will tamp later in time. Additionally, by grading the density of propellant region 110, one can then tailor the pushing profile (pressure vs. time) on the outer shell 108. Grading the density within such a region is accomplished by any one of a variety of ways as described above.

When the shock driven through outer fuel region 106 reaches inner shell 104, the shell will be accelerated inwardly and may reach a peak inward velocity of approximately 2.0×10⁷ cm/s. The inward motion of inner shell 104 and the convergence of the shock it launches will result in compression and heating of the fuel in inner fuel region 102. The peak areal density (ρr) reached in inner fuel region 102 may be 1.1 g/cm². Because of this relatively high areal density, the dominant energy loss mechanism of the fuel may be radiation emission. The high radiation opacity of inner shell 104 lowers the radiative energy loss of the fuel in inner fuel region 102 by reflecting a substantial fraction of radiated energy back into inner fuel region 102. Because of this, ignition of the fuel in inner fuel region 102 may occur at a relatively low temperature of 2.5-2 keV. Once ignited, the temperature of the fuel in inner fuel region 102 may rise further due to self-heating effects, and fusion reactions in inner fuel region 102 may produce a substantial amount of energy, e.g., approximately 36 MJ.

The high temperatures and pressures produced by fusion yield in inner fuel region 102 drive inner shell 104 outward. Outer fuel region 106 is compressed and heated by the outward motion of inner shell 104 and the remaining inward motion of outer shell 108. Outer fuel region 106 is further heated by scattering of neutrons produced by fusion reactions in inner fuel region 102 and/or by radiation emitted by fuel in inner fuel region 102. This heating and compression may lead to substantial additional fusion fuel reactions in outer fuel region 106, which in this embodiment may produce an additional 5 MJ of yield.

In some embodiments, outer fuel region 106 may ignite and undergo runaway burn, and the majority of fusion yield from the target may be produced in outer fuel region 106. In some embodiments, heating by neutron scattering may be sufficient to heat outer fuel 106 to ignition temperature, before the PdV heating from inner shell 104 becomes significant. Increasing pr of outer fuel region 106, e.g., by scaling the entire target proportionally to a greater size, may increase the relative fraction of yield produced by outer fuel region 106 and/or lower the threshold required for ignition of outer fuel region 106.

The implosion process of this embodiment has numerous advantages relative to that utilized by conventional ICF targets. This “propellant drive” mechanism utilizing a short laser pulse to energize a closed hohlraum is straightforward to model and analyze: the spherically symmetric geometry is less complicated than the sphere-in-cylinder geometry used in conventional ICF, and the short pulse length means that the laser absorption and target drive are accomplished before significant hydrodynamic motion has occurred. As a result, laser coupling and absorption in the ICF target is separated in time from the implosion of the target. Coupling the laser to the target during the implosion may cause asymmetrical absorption of the laser light due to material movement. This asymmetrical implosion would then cause the target to not ignite. Furthermore, due to the high reflectivity of outer shell 108 and hohlraum 112, there may be significant radiation smoothing of the temperature non-uniformity in propellant region 110, which in some embodiments may substantially improve the uniformity of the target drive and smooth any non-uniformity in the laser energy delivered.

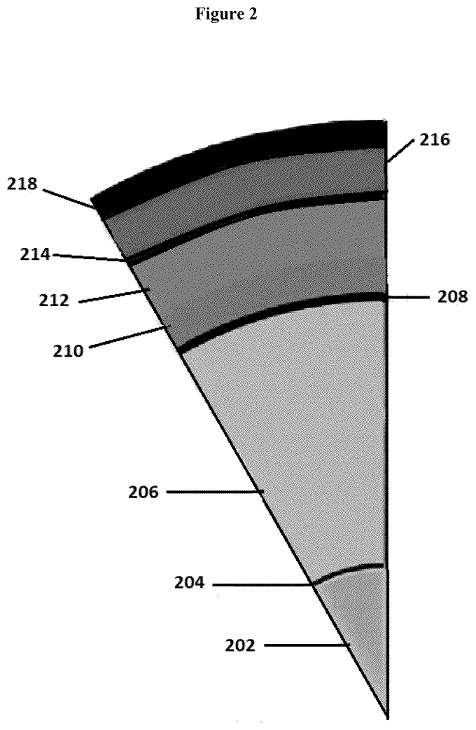

Target assembly 200 (FIG. 2) comprises a central spherical region with sparkplug 202. Sparkplug 202 may comprise deuterium-tritium gas having a low-density of about 0.07 g/cm³. Surrounding sparkplug 202 is cap 204 and then fuel region 206. Cap 204 comprises a high-Z material, such as tungsten, having an outer radius of about 0.1 cm and density of about 19.25 g/cm³. Fuel region 206 comprises deuterium-tritium gas having an outer radius of about 0.3 cm and a low-density of about 0.2 g/cm³. A density higher than this would change the phase of deuterium-tritium to be in a solid-state phase. Surrounding fuel region 206 is pusher shell 208 followed by two propellant regions 210 and 212. Propellant regions 210 and 212 are unique and distinct from one another and may not have the same density nor thickness but the outer propellant region 212 will have a higher density than the inner propellant region 210. Surrounding propellant regions 210 and 212 is a thin layer or lamina 214 having an outer radius of about 0.39 cm and a density of about 19.3 g/cm³ before void region 216. Void region 216 has an outer radius of about 0.43 cm. Case 218 having an outer radius of about 0.45 cm, surrounds void region 216 wherein the line represents the laser deposition area. Table 1 provides the optimal dimensions for each of the layers/regions of ICF target assembly 200 wherein the layers/regions are laminated together by various known means or conjoined via a low-density material having about 0.1 g/cc.

TABLE 1
ICF Target Assembly as shown in FIG. 2

| | Outer Radius | |
|---|---|---|
| | from center (cm) | Density (g/cc) |
| Case (218) | 0.45 | 19.25 |
| Void Region (216) | 0.43 | 0 |
| Thin Layer (214) | 0.3944 | 19.3 |
| 2^{nd} Propellant (212) | 0.3942 | 2 |
| 1^{st} Propellant (210) | 0.34 | 1.5 |
| Pusher (208) | 0.32 | 19.25 |
| Fuel (206) | 0.31 | 0.2 |
| Cap (204) | 0.11 | 19.25 |
| Sparkplug (202) | 0.105 | 0.07 |

Alternatively, void region 216 could be filled with any one of a variety of materials. A low-Z material having a density of less than 0.1 g/cc, such as Helium gas would be one of a variety of possible materials that would make an excellent choice for void region 216. Additionally, the material and thickness of void region 216 may be adjusted in order to reduce the non-uniformity of the x-ray radiation. Void region 216 could also be filled with low-density high-Z radiators (not shown) dispersed through void region 216 designed to absorb the laser light energy and convert it to x-ray radiation. A material such as gold would be one of a variety of possible materials that would make an excellent choice for the low-density, high-Z radiator.

The implosion process of this embodiment has numerous advantages relative to that utilized by conventional ICF targets. In operation, an external drive mechanism delivers laser light to ICF target assembly 200, first reaching case 218. This particular dimension of the thin layer or lamina 214 as suggested in Table 1, converts the incoming laser energy into x-ray radiation. Due to the particular selection of materials, dimensions, composition and densities as detailed above, the x-ray radiation will continue to re-radiate, bounce between thin layer or lamina 214 and case 218. Initially, the x-ray radiation field begins with a higher level of non-uniformity within the thin layer or lamina 214, but as it re-radiates it will continue to smooth out until thin layer or lamina 214 becomes completely ionized. For example, utilizing a high-Z material like gold for thin layer or lamina 214 allows for about a 1% rms non-uniformity of the radiation field as opposed to using a low-Z material which would give about 5% rms non-uniformity of said radiation field. This configuration, specifically the use of a void region 216 and thin layer or lamina 214 as described above, advantageously will allow for a smoother profile while still using a dense propellant region. Previously, an ICF target would be unable to smooth the radiation of such configuration as effectively due to these various reasons.

Due to the precise selection of the dimensions, densities, and materials of the ICF target as suggested in Table 1, the ICF target is uniquely designed for a uniform and efficient use of this energy to compress, heat and ignite the fusion fuel within it. Once the thin layer or lamina 214 is completely burned through, the x-ray radiation drives a thermal wave into the propellant regions 210 and 212. A thermal wave propagates at a subsonic speed to penetrate the propellant regions 210 and 212. This thermal wave ionizes the material without any significant hydrodynamic motion to occur within these regions and does so without ablating the surface nor is a shock driven into the material. Void region 216 will become optically thin almost instantaneously which allows for the laser radiation to smooth very quickly, such as within approximately 1 nanosecond. This is extremely important because it allows for the non-uniformity in the x-ray radiation to be smoothed and then passed on to energize the propellant regions 210 and 212 and the subsequent shock that the pusher shell 208 creates by its implosion. This invention may substantially improve the uniformity and efficiency of the ICF target drive and smooth any non-uniformity in the laser energy delivered.

Additionally, the embodiments discussed in this application are exemplary and not an exhaustive enumeration of variants. Features discussed as part of separate embodiments may be combined into a single embodiment. Further, embodiments may make use of other features known in the art but not explicitly cited in this application.

1. A system for controlling a pushing profile of an Inertial Confinement Fusion (ICF) target when imploding, the system comprising:
a spherical sparkplug located in an innermost center of the ICF target, wherein the sparkplug has a density of approximately 0.07 g/cm³;
a cap concentrically adjacent said spherical sparkplug, wherein the cap has an atomic number of 48 or greater and a density of approximately 19.25 g/cm³;
a fusion fuel region concentrically adjacent said cap, wherein the fusion fuel region has a density of approximately 0.2 g/cm³;
a pusher shell concentrically adjacent said fusion fuel region;
a lamina concentrically adjacent said pusher shell, wherein the lamina has a density of about 19.3 g/cm³; and
a case concentrically adjacent said lamina.

2. The system as in claim 1, the system further comprising:
a void region concentrically surrounding said lamina.

3. The system as in claim 2, the system further comprising:
wherein the void region is filled with a material having an atomic number of 5 or less, and a density of less than 0.1 g/cc.

4. The system as in claim 3, the system further comprising:
wherein the void region has an outer radius at approximately 0.43 cm from the center of the ICF target.

5. The system as in claim 4, the system further comprising:
wherein the lamina has an outer radius at approximately 0.4 cm from the center of the ICF target.

6. The system as in claim 5, the system further comprising:
wherein the lamina comprises a material having an atomic number of 48 or greater.

7. The system as in claim 6, the system further comprising:
a first propellant region concentrically located outside of the pusher shell; and
a second propellant region concentrically located outside of the first propellant region and inside of the lamina, wherein the first propellant region and the second propellant region are distinct and unique from one another.

8. The system as in claim 7, the system further comprising:
wherein the second propellant region has a higher density than the first propellant region.

9. The system as in claim 8, the system further comprising:
wherein the fusion fuel region has an outer radius at approximately 0.3 cm from the center of the ICF target.

10. The system as in claim 9, the system further comprising:
a plurality of radiators dispersed throughout the void region, wherein each of the plurality of radiators are composed of a material having an atomic number of 48 or greater.

11. A method for controlling a pushing profile of an Inertial Confinement Fusion (ICF) target when imploding, the method comprising:
delivering laser energy toward an ICF target, wherein the laser energy first reaches a concentrically located case, an outer most layer of the ICF target;
the ICF target comprising:
a spherical sparkplug located in a center of the ICF target, wherein the sparkplug has a density of approximately 0.07 g/cm³;
a cap concentrically adjacent said spherical sparkplug, wherein the cap has an atomic number of 48 or greater and a density of approximately 19.25 g/cm³;
a fusion fuel region concentrically adjacent said cap, wherein the fusion fuel region has a density of approximately 0.2 g/cm³;
a pusher shell concentrically adjacent said fusion fuel region;
a lamina concentrically adjacent said pusher shell, wherein the lamina has a density of about 19.3 g/cm³;
a case concentrically adjacent said lamina; and
converting the laser energy into x-ray radiation as it reaches the lamina due to the selection of the distinct density of the lamina.

12. The method as in claim 11, the method further comprising:
selecting a material of the lamina to comprise an atomic number of 48 or greater;
converting incoming laser energy into x-ray radiation as the laser energy reaches the lamina due to the selection of the distinct material of the lamina.

13. The method as in claim 12, the method further comprising:
selecting an outer radius for the lamina to be approximately 0.4 cm from the center of the ICF target; and
converting incoming laser energy into x-ray radiation as the laser energy reaches the lamina due to the selection of the distinct dimension of the lamina.

14. The method as in claim 13, the method further comprising:
wherein the ICF target further comprises a void region concentrically surrounding said lamina, wherein the void region has a density of less than approximately 0.1 g/cc; and
re-radiating the x-ray radiation within this void region until the lamina becomes ionized due to the selection of the distinct density of the void region.

15. The method as in claim 14, the method further comprising:
selecting a distinct material of the void region to comprise an atomic number of 5 or less, and a density of less than approximately 0.1 g/cc; and
reradiating the x-ray radiation within the void region until the void region becomes optically thin due to the selection of the distinct material and density of the void region.

16. The method as in claim 15, the method further comprising:
selecting an outer radius of the void region to be approximately 0.43 cm from the center of the ICF target; and
reradiating the x-ray radiation within the void region until the void region becomes optically thin due to the distinct selection of the dimension of the void region.

17. The method as in claim 16, the method further comprising:
driving a thermal wave into a second propellant region and a first propellant region at a subsonic speed after the limina becomes completely ionized,
wherein the first propellant region is concentrically located outside of the pusher shell, the second propellant region is concentrically located outside of the first propellant region, and the first propellant region and the second propellant region are distinct and unique from one another.

18. The method as in claim 17, the method further comprising:
penetrating the second propellant region and the first propellant region with the thermal wave without ablating the second propellant region and the first propellant region.

19. The method as in claim 18, the method further comprising:
wherein the fusion fuel region has an outer radius at approximately 0.3 cm from the center of the ICF target.

20. The method as in claim 19, the method further comprising:
dispersing a plurality of radiators throughout the void region, wherein each of the plurality of radiators are composed of a material having an atomic number of 48 and greater; and
absorbing the laser energy and converting it to x-ray radiation by the plurality of radiators.
